(19) United States
(12) Patent Application Publication
(10) Pub. No.: US 2011/0093924 A1
(43) Pub. Date: Apr. 21, 2011

(54) SYSTEM FOR COLLECTING AND ORGANIZING GAME STATISTICS, INFORMATION AND APPLICATIONS FOR DISTRIBUTION, ANALYSIS AND ENTERTAINMENT, AND METHOD

(75) Inventor: Dustin David Thompson, Charlotte, NC (US)

(73) Assignee: STATILLAC CORPORATION, Charlotte, NC (US)

(21) Appl. No.: 12/581,908

(22) Filed: Oct. 20, 2009

(51) Int. Cl. G06F 15/16; G06F 21/20

(52) U.S. Cl. 726/4; 709/205

(57) ABSTRACT

A web-based and accessible sports statistics, information and application system configured to establish a hierarchy of rights controlling access by users to sports statistics stored in the system, establish a hierarchy of permissions to be granted to users based on the hierarchy of rights, establish a hierarchy of reports that can be downloaded by users based on their rights and permissions, and permit synchronization of a team roster and team statistics between the user's database information on a personal computer with database information on the website database.

### TECHNICAL FIELD AND BACKGROUND OF THE INVENTION

This invention relates to a system for collecting and organizing game statistics, information and applications for distribution, analysis and entertainment. The invention also discloses a method by which the stated objects, and others, of the invention may be efficiently practiced. The system and method according to this application offers a computer-based network that is user-friendly and adapted particularly for athletic directors (AD's), athletic coaches, team players, statisticians, scouts, journalists and sports fans. A wide variety of statistics are made available in a hierarchical manner that allows access based on the status of the participant. The system organizes the game statistics into two categories—basic statistics for all classes of participants, and advanced statistics for use by coaches and AD's. Other information, such as game schedules, player rosters and the like are also made available.

The ability to track team statistics has been known and practiced for many years. Originally these statistics were created and tracked manually and were available almost exclusively to teams for use in evaluating player and team performance, optimizing play based on historical performance data, and determining trends and tendencies in both the team being tracked and preparing offensive and defensive countermeasures. Activity by non-team participants was limited to a few publically-available statistics, such as batting averages, earned run averages, passing percentages, and the like, depending on the sport being tracked.

More recently, the availability of computers has permitted far more sophisticated statistical tracking to be carried out by a team to track its own performance and the performance of opponents. However, these statistics in their most useful form are considered confidential and are almost never available to non-team members.

### SUMMARY OF THE INVENTION

It is therefore an object to provide a statistical database and method that permits certain statistics that are a subset of an array of statistical information stored in a computer-accessible database to be accessed by individual participants based on their established status within a hierarchy of individual participants having an assigned status based on their relationship to the team.

It is another object to provide a statistical database system and method that is internet based and permits users according to an established hierarchy to enter a website and synchronize database information on their personal computer with database information on the website database.

It is another object to provide a statistical database system and method that permits interactive participation between and among participants in a controlled manner based on their established status within a hierarchy of individual participants, including communication to a participant initiated by the website in order to furnish game statistics at predetermined intervals.

It is another object to provide a on-line website and database system and method that permits interactive participation between and among participants in a controlled manner based on their established status within a hierarchy of individual participants, including communication to a participant initiated by the website in order to furnish game statistics at predetermined intervals, that permits access to statistics, team information and applications.

It is another object to provide a on-line website and database system and method that permits interactive participation between and among participants that permits tracking of players by fans, and creation, downloading and maintenance of team and player profiles by users, including fans, by tagging players and player statistics and other information, such as photographs.

According to one embodiment of the invention, a web-based and accessible sports statistics system is provided, and is configured to establish a hierarchy of rights controlling access by users to sports statistics stored in the system, and a hierarchy of permissions to be granted to users based on the hierarchy of rights. A hierarchy of reports is established that can be downloaded by users based on their rights and permissions. The system permits synchronization of a team roster and team statistics between the user's database information on a personal computer with database information on the website database.

According to another embodiment of the invention, the users comprise fans, ADs, coaches, players, scouts and statisticians.

According to another embodiment of the invention, the method includes the step of allowing the users to view and download reports of sports statistics based on the hierarchy of permissions to be granted to the users.

According to another embodiment of the invention, the method includes the step of allowing a school having one or more sports teams to subscribe to the web-based and accessible sports statistics system. The method includes the step of allowing the school to designate an AD who may approve one or more coaches, and allowing the one or more ADs and one or more coaches to approve one or more statisticians.

According to another embodiment of the invention, the system includes the step of allowing the AD and/or coach to create and upload player rosters for a sport and for a series of sports.

According to another embodiment of the invention, the method includes the step of permitting a player on a roster to access the system to view event schedules contained in the system.

According to another embodiment of the invention, the method includes the step of permitting the AD and/or coach to enter event schedules in the system, comprising practice sessions, workout sessions, team meetings, player meetings, and scheduled games.

According to another embodiment of the invention, the method includes the step of allowing only the AD and/or coach to view and schedule the events.

According to another embodiment of the invention, the method includes the step of permitting users other than ADs and coaches to view only scheduled games of the events schedule on the system.

According to another embodiment of the invention, the method includes the step of allowing users to establish a user-created profile and synchronize the user-created profile with specific team and/or player specific data downloaded from the system.

According to another embodiment of the invention, the method includes the step of allowing only a user having rights and permissions of a statistician to download from the system software for creating team and player statistics by entering data into the system and synchronize player roster data with the player roster created by an AD or coach.

According to another embodiment of the invention, the method includes the step of permitting an AD, coach and statistician to upload statistics to the system.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is a flow chart illustrating steps 1 and 2 of the initiation of the on-line registration process;

FIG. 2 is a flow chart illustrating steps 3 and 4 of the initiation of the on-line registration process, and the step of the AD and/or coach using the roster feature of the system;

FIG. 3 is a flow chart showing the step of the coach approving or denying a player request for access to the system;

FIG. 4 is a flow chart showing the step of the statistician downloading statistics entry software onto the statistician's computer in preparation for data entry;

FIG. 5 is a flow chart showing the step of the statistician synchronizing a team roster and uploading game statistics from the statistician's computer to the system database;

FIG. 6 is a flow chart showing creating of team and player statistics for a particular school;

FIG. 7 is a flow chart showing registration to be a coach or statistician with permissions relating to the system;

FIG. 8 is a flow chart illustrating the access status of certain users of the system;

FIG. 9 is a flow chart illustrating the access status of certain other users of the system;

FIG. 10 is a an overall flow chart showing status and permissions of various categories of users;

FIG. 11 is a flow chart showing how a user tags a player and that player's game statistics;

FIG. 12 is a screen shot of the entry menu page of the system;

FIG. 13 is a screen shot of a school profile page of the system;

FIG. 14 is a screen shot of a coach approval entry page of the system.

FIG. 15 is a screen shot of a user removal data entry page of the system.

FIG. 16 is a screen shot of a player selection (by jersey number) entry page of the system;

FIG. 17 is a screen shot of a player selection (by name) entry page of the system;

FIG. 18 is a screen shot of an entry page of the system used for joining a network of the system based on user type;

FIG. 19 is a screen shot of an entry page of the system used for joining a network of the system based on the type of sport played by an athlete user;

FIG. 20 is a screen shot of a dialog page of the system indicating that an athlete's request is being sent to a coach for approval;

FIG. 21 is a screen shot of an athletic approval page of the system;

FIG. 22 is a screen shot of an entry page of the system used by a statistician to join the system network;

FIG. 23 is a screen shot of a statistician approval page of the system;

FIG. 24 is a screen shot of a page of the system showing a statistics selection page for a specific opponent;

FIG. 25 is a screen shot of a page of the system showing an overview of game statistics for a specific game for a specific opponent;

FIG. 26 is a screen shot of a page of the system showing a team roster;

FIG. 27 is a screen shot of a page of the system showing a team schedule of a type available to certain users such as the AD, coach and players;

FIG. 28 is a screen shot of a page of the system showing a team schedule of a type available to certain users such as fans;

FIG. 29 is a screen shot of a page of the system showing graphical representations of tendencies of certain plays by an opponent team;

FIG. 30 is a continuation of the screen shot of FIG. 29;

FIG. 31 is a screen shot of a page of the system showing graphical and table representations of team offense statistics;

FIG. 32 is a screen shot of a page of the system showing a status update entry form;

FIG. 33 is a screen shot of a page of the system showing a list of player-specific tagged statistics;

FIG. 34 is screen shot showing a user data and system entry information;

FIG. 35 is a screen shot showing a school search data entry form;

FIG. 36 is a screen shot showing a AD data entry form for joining the system;

FIG. 37 is a screen shot showing a continuation of the AD data entry form for joining the system; and

FIG. 38 is a screen shot showing an approval dialog showing approval of a AD joining the system.

### DESCRIPTION OF THE PREFERRED EMBODIMENTS AND BEST MODE

Referring generally to the drawings, a system for collecting and organizing game statistics, information and applications for distribution, analysis and entertainment and related method according to the present invention is shown generally the drawing figures. The embodiments of the invention disclosed in this application are now described more fully with reference to the accompanying figures in which exemplary embodiments of the invention are shown. However, the invention may be embodied in many different forms and should not be construed as limited to the representative embodiments set forth in this application. The exemplary embodiments are provided so that this disclosure will be both thorough and complete, and will fully convey the scope of the invention and enable one of ordinary skill in the art to make, use and practice the invention.

The present invention is described below with reference to flow and block diagrams illustrating methods, apparatuses (i.e., systems) and computer program products according to preferred embodiments of the invention. It will be understood that each block of the diagrams, and combinations of blocks in the diagrams, respectively, can be implemented by computer program instructions. These computer program instructions may be loaded onto a server, a special purpose computer, a programmed general purpose computer, or other programmable data processing apparatus to produce a machine, such that the instructions that execute on the computer or other programmable data processing apparatus implement the functions specified in the flow and block diagrams, and otherwise described and illustrated.

Accordingly, blocks of the diagrams support combinations for performing the specified functions, combinations of steps for performing the specified functions and program instructions for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

The system includes an operating system and a processor that communicates with other elements within the system via a system interface or bus. Also included in the system is a display device/input device for receiving, inputting and displaying data. The system further includes memory, which preferably includes both read only memory (ROM) and random access memory (RAM). The system's ROM is used to store a basic input/output system (BIOS), containing the basic routines that help to transfer information between elements within the system. Alternatively, the claims processing system can operate on one computer or on multiple computers networked together.

In addition, the system includes at least one storage device, such as a hard disk drive, a CD/DVD Rom drive or optical disk drive, for storing information on various computer-readable media, such as a hard disk, a removable magnetic disk or a CD/DVD-ROM disk. As will be appreciated by skilled in the art, each of these storage devices is connected to the system bus by an appropriate interface. The storage devices and their associated computer-readable media provide nonvolatile storage for a personal computer.

Application modules are stored by the various storage devices and within RAM.

An algorithm according to which a system according to an embodiment of the invention operates is described below:
Step 1: Fan, AD, Coaches, Scout, Statistician etc. (users) join the Statillac website.
Step 2: Users can see reports based on their rights.
Step 3: School sign up for the system website.
Step 4: website approves AD.
Step 5: AD approves Coaches.
Step 6: AD or Coach approves statistician.
Step 7: AD and/or Coach create roster for the game season and games.
Step 8: User sends a request to coach to add as a player, and tag pictures and videos to the school homepage.
Step 8: Coach approves user as a player then player can see all events (practice, workouts, meetings and games) on team calendar.
Step 9: Coach and AD can see and manage all events in the team calendar.
Step 10: Fan, Scout, Statistician can only see the game events on the team calendar.
Step 11: A player on the roster can be sync with the player profile.
Step 12: Users can tag player specific statistics to their profile by clicking specific statistical categories single selections for a specific player or players on the team's roster.
Step 13: Only the statistician can download the software for taking stats.
Step 14: Statistician can synchronize roster with the online roster created by the AD or Coach.
Step 15: Statistician, Coach and AD upload stats to the system database.
Step 16: Website produces stat report from the system database.
Step 17: AD manages the school team home page.

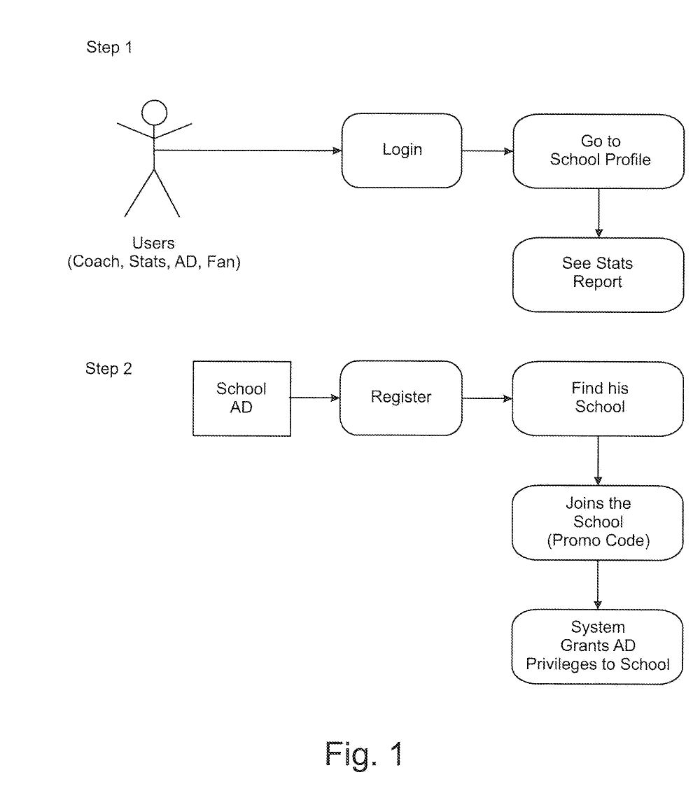

Referring now specifically to the drawings FIGS. 1-11, the steps followed by users in establishing and exercising rights is illustrated. In FIG. 1, users, such as coaches, ADs, statisticians and fans, log-in to the system, select a profile for the appropriate school, and are then able to view statistical reports based on their status. In step 2, the school AD registers, finds and joins his school. The system grants AD privileges to the school.

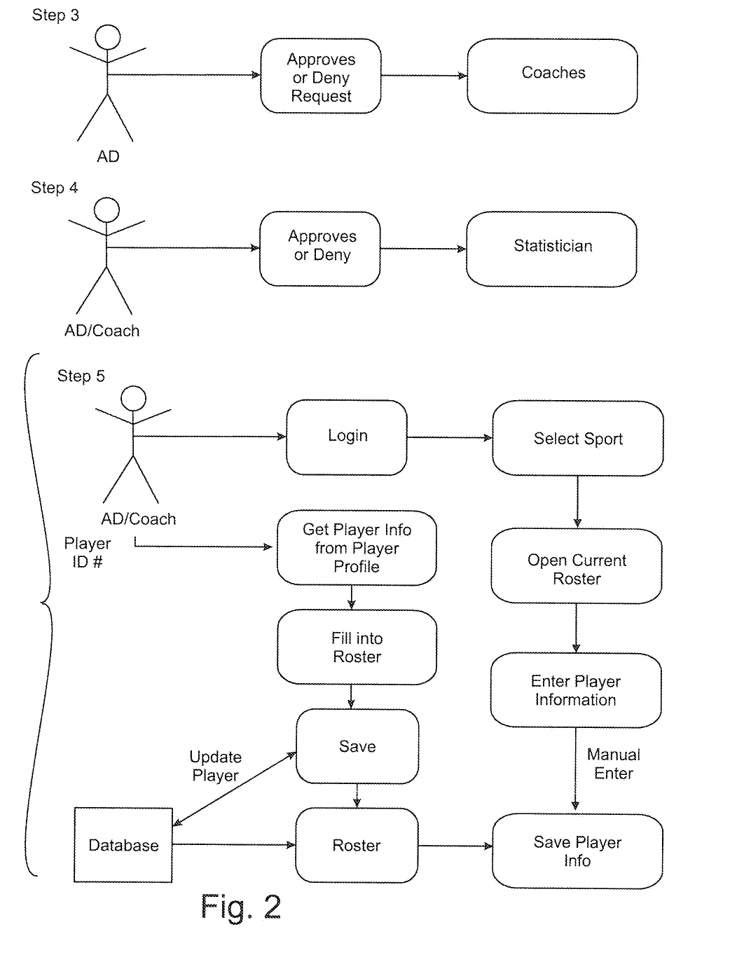

As is shown in FIG. 2, the AD is authorized to approve or deny approval to coaches to become a part of the system and thus have access to the system in accordance with coaches rights, as shown in step 3. The AD and coach each have the right to grant access privileges to statisticians, as shown in step 4. In step 5, the AD and/or coach thus have access upon proper login to carry out the functions shown. Player identification information is entered into the roster, saved and used to update the system database. The system database is also used to update the roster and player information.

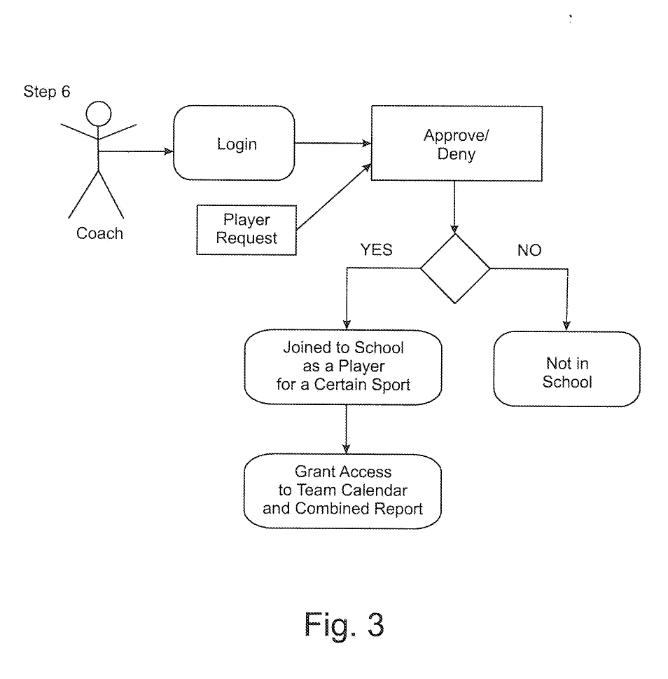

Referring now to FIG. 3, in step 6 the coach has the right to approve or deny requests from players to join the roster, based on whether the player is or is not properly enrolled in the school. If properly in school, the player has access to the team calendar and specified reports.

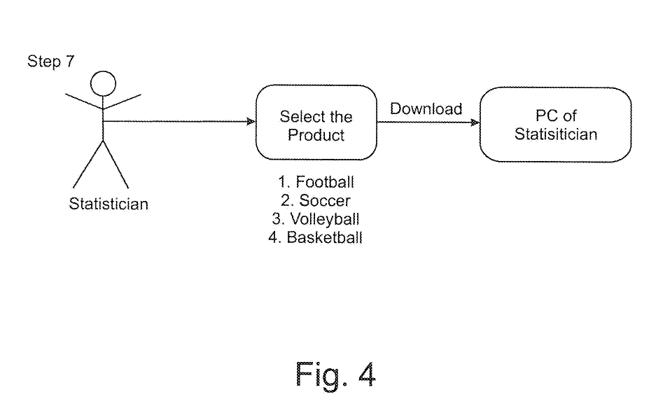

In FIG. 4, a statistician, who has previously been approved, as in FIG. 2, step 4, can access the system, select software used to enter statistics, and then download sport-specific software onto the statistician's own computer for use in data entry. The sport-specific software includes data entry forms based on sports-specific plays, i.e., pitches, steals, passes, interceptions, goals, etc., as well as underlying calculations that determine the number of plays, average values for plays, and the like.

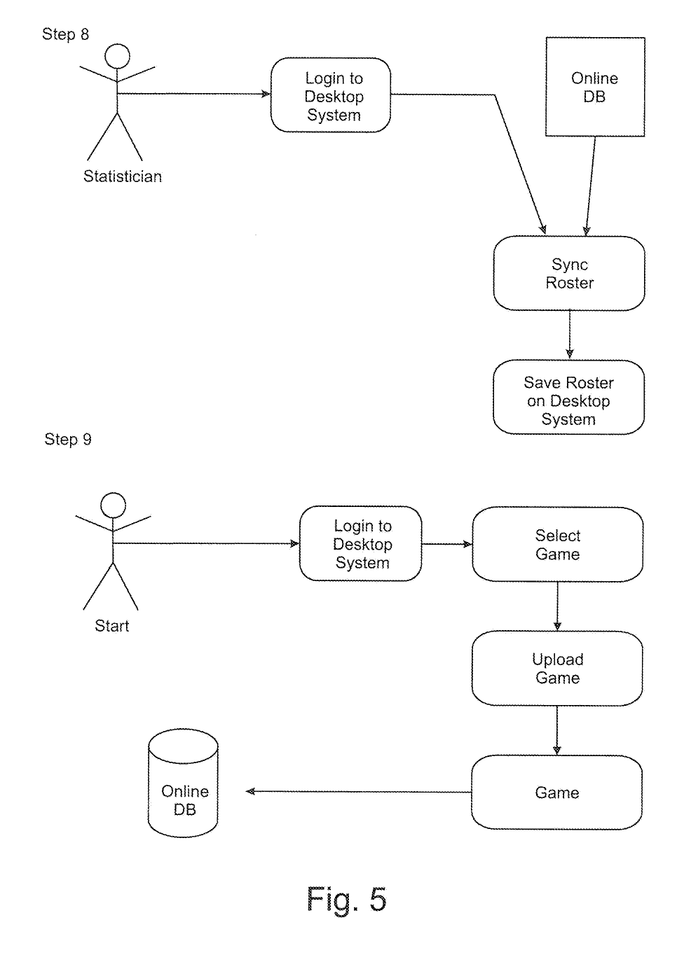

Referring to FIG. 5, in step 8 the statistician has permission to log into the statistician's own computer, access the online database and synchronize data, including team rosters, from the database with the statistician's own computer. Then, as shown in step 9, the statistician logs in to the statistician's own computer, selects and uploads game data, including rosters, and then enters event data as the game is played. This data is then uploaded onto the system's online database.

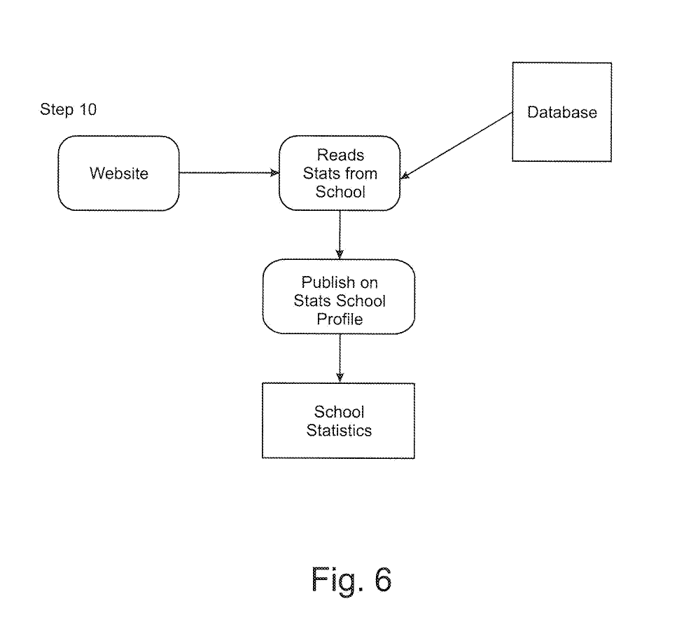

FIG. 6, step 10, illustrates that the website and online database each supply statistical information to a school profile which in turn is available to users based on permissions granted the users to supply school statistics. For example, an AD and a coach, who may the different or the same individual, would ordinarily have access to all information, whereas statisticians, players and users have lesser privileges in keeping with the need for confidentiality.

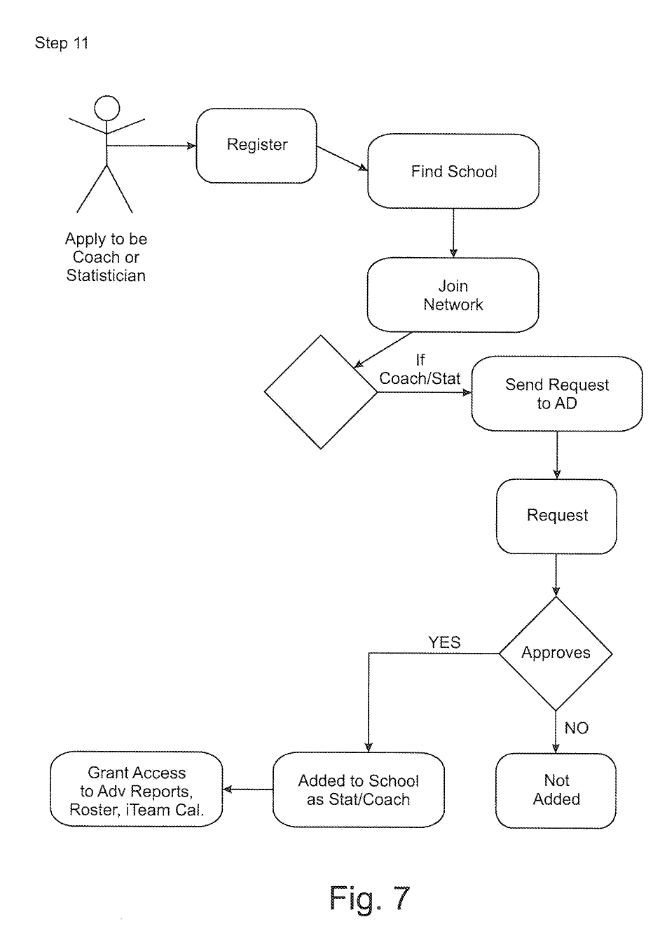

FIG. 7, step 11, illustrates the process by which a person may apply to be a coach or statistician. The person registers on the website, finds the correct school and joins a network that includes that school. A request is then sent to the correct AD, who considers the request. If the request is approved, the person is added to the school network as a coach or statistician and is granted access to advanced reports, the roster, team calendars, and the like.

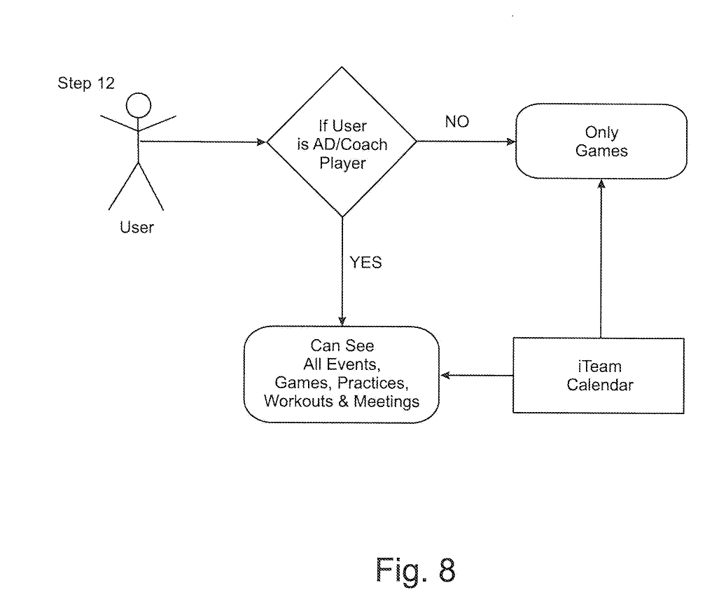

FIG. 8, step 12, illustrates that permissions are granted based on status, so that if the user is an AD, coach or player, access is granted to all events, including games, workouts, practices and meetings. If a fan, access is granted only to game information, which is updated from a game calendar.

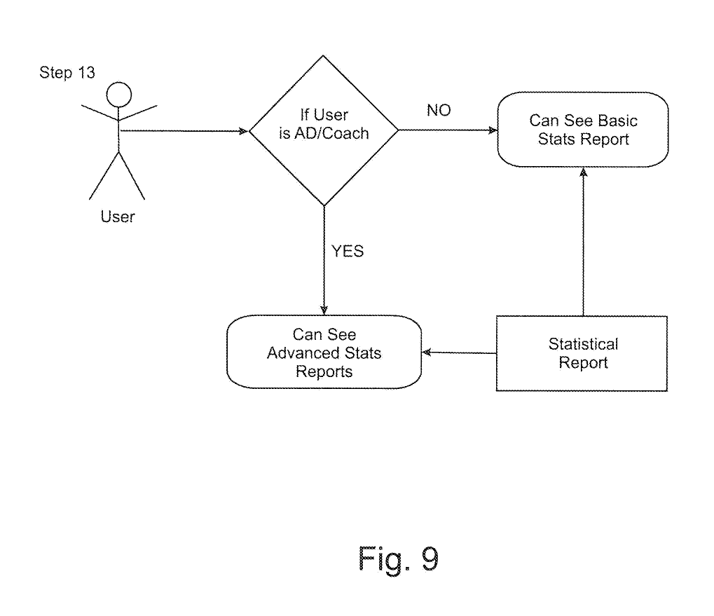

FIG. 9, step 13, illustrates that if the user is an AD and/or coach, access would be to advanced statistics and reports, rather than to basic statistics and reports. Statistical information is used to populate both basic and advanced reports, but access is controlled based on permissions granted in the sign-up and login processes.

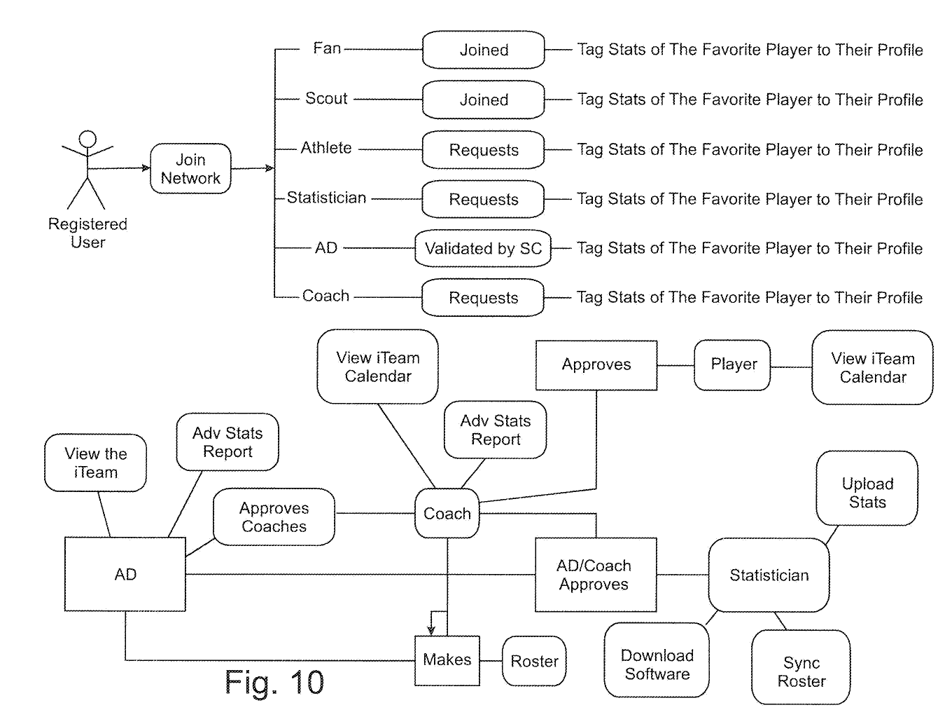

FIG. 10, provides an overall summary of the system organization. The registered user joins with one or more of several designations, such as a fan, scout, player (athlete), statistician, AD and/or coach. Each may select and tag statistics or one or more favorite players and download to a profile maintained by the user. FIG. 10 also illustrates the respective responsibilities and rights of the AD and Coach (who may be the same person).

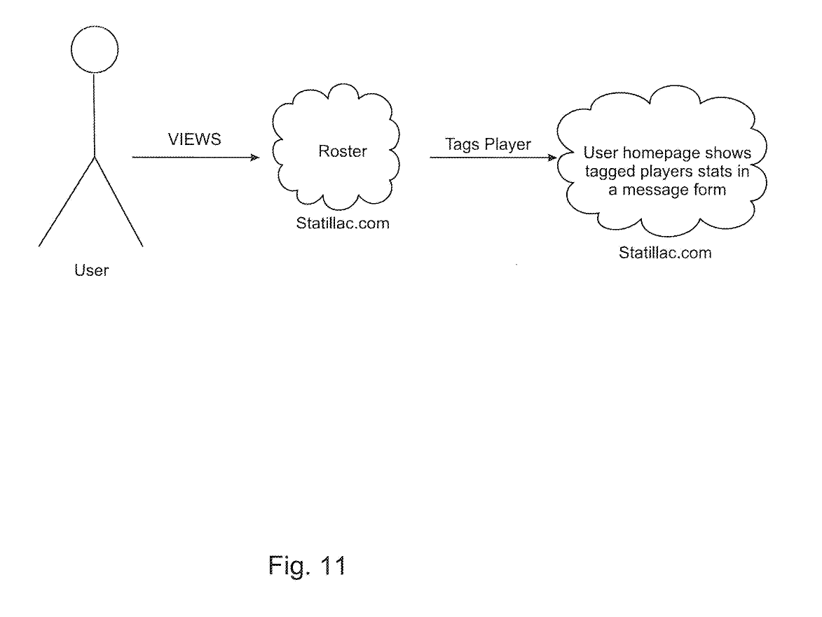

The tagging process is shown in FIG. 11.

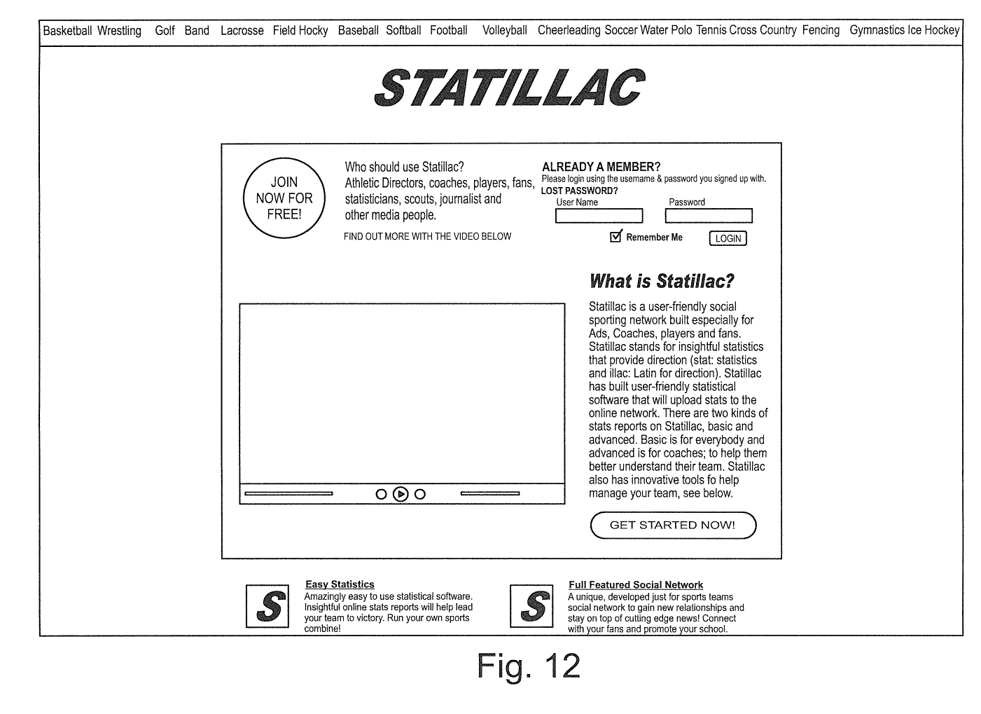

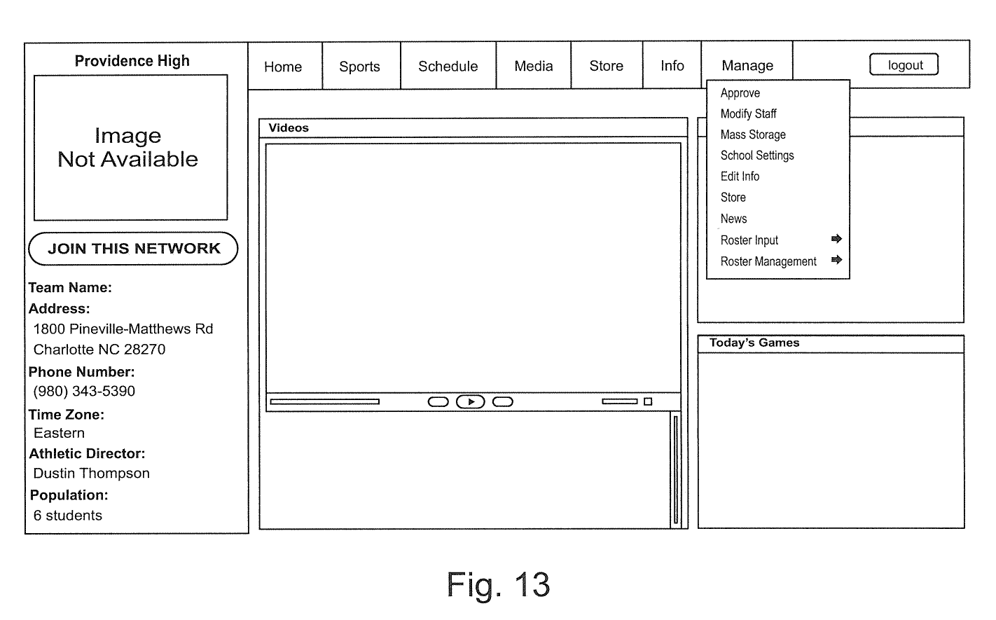

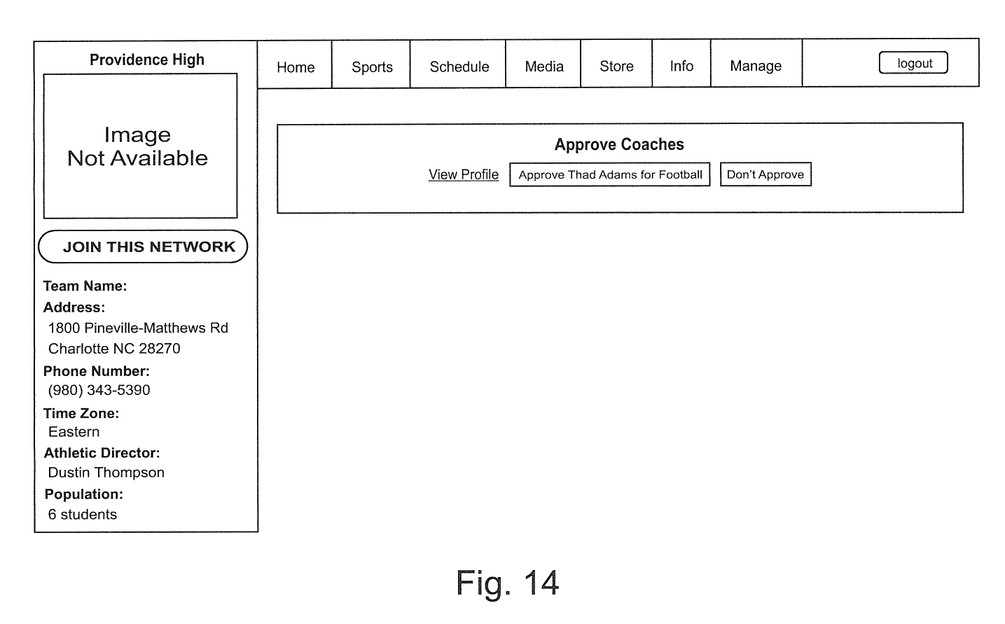

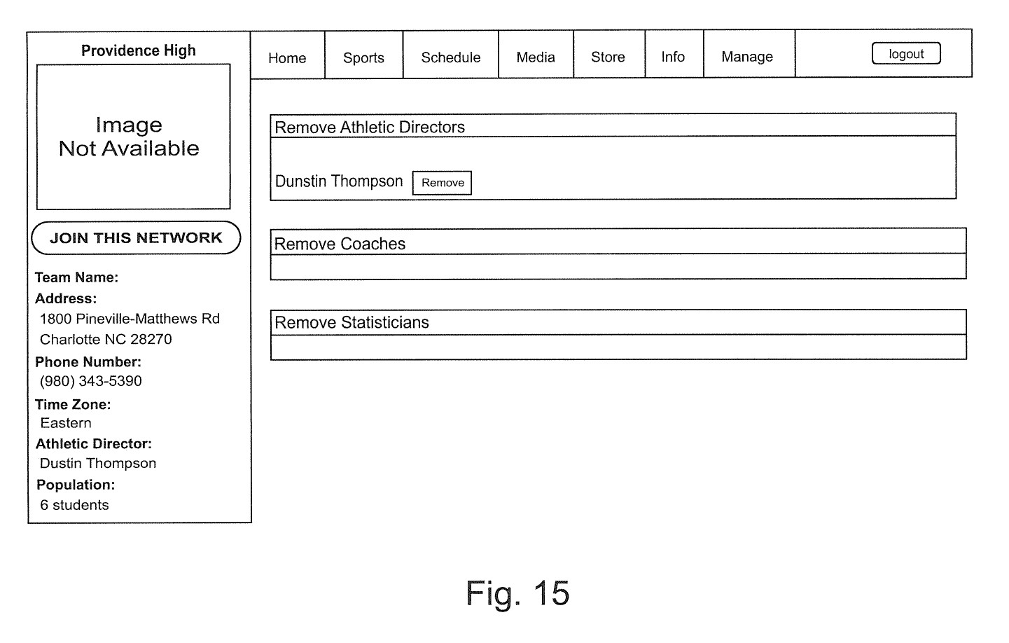

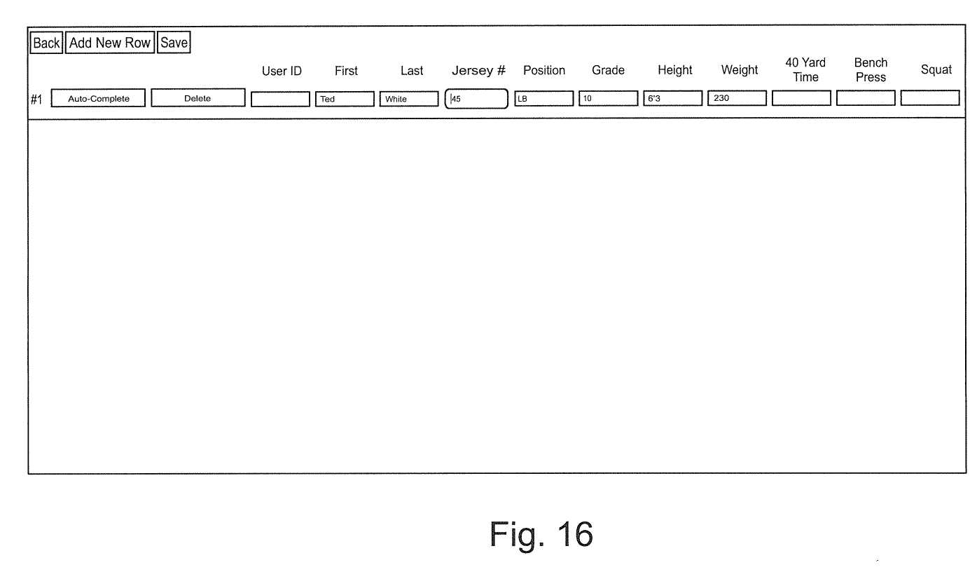

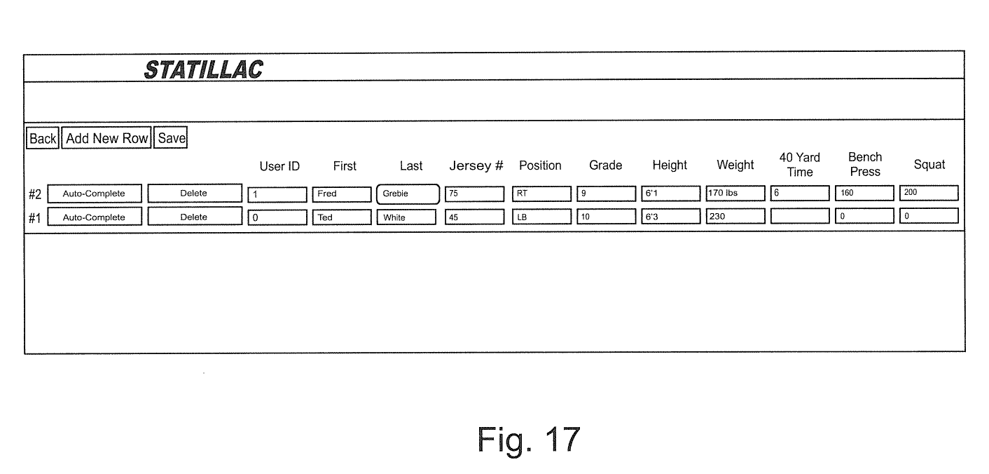

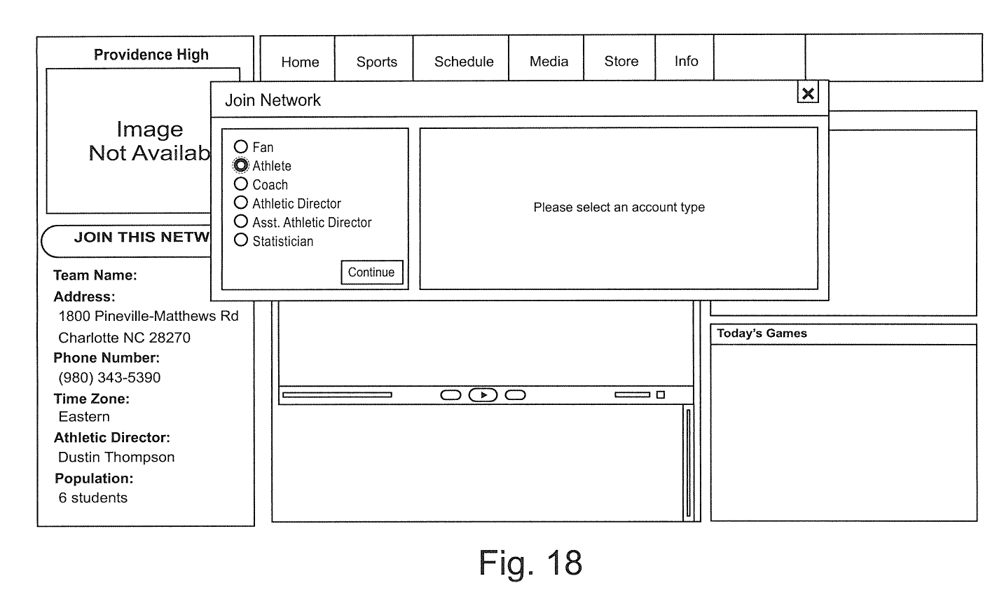

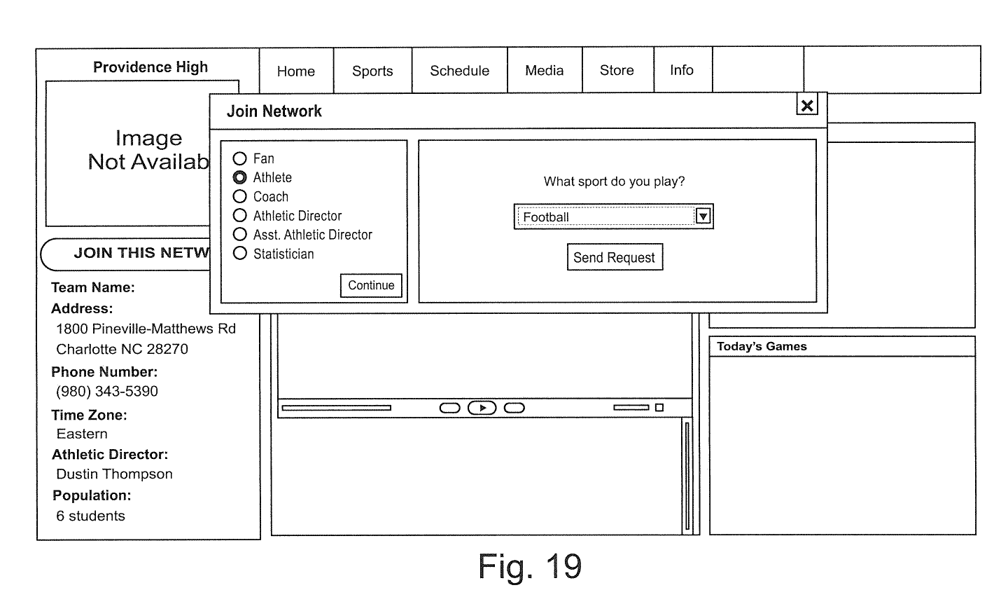

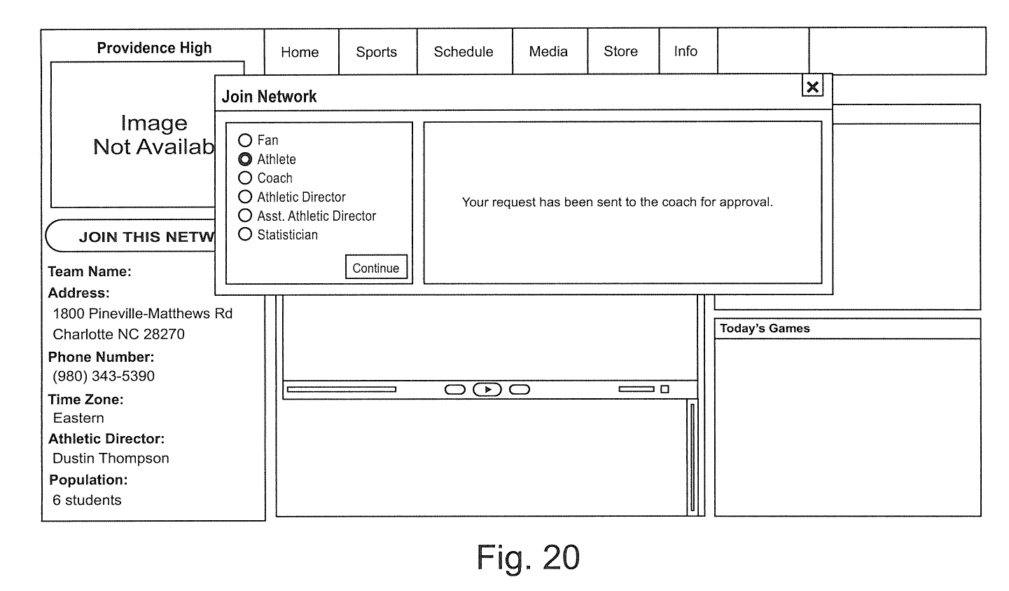

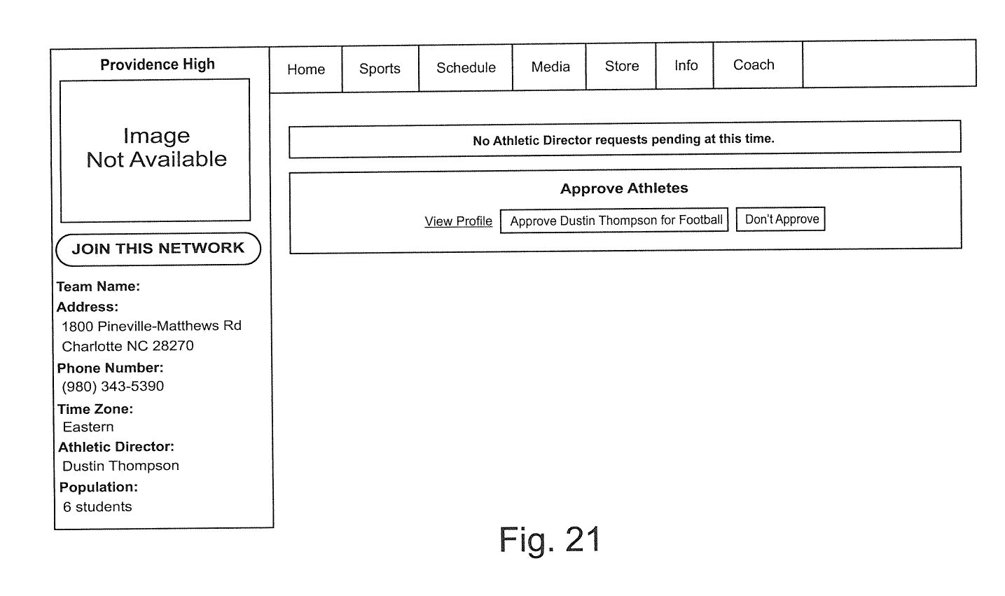

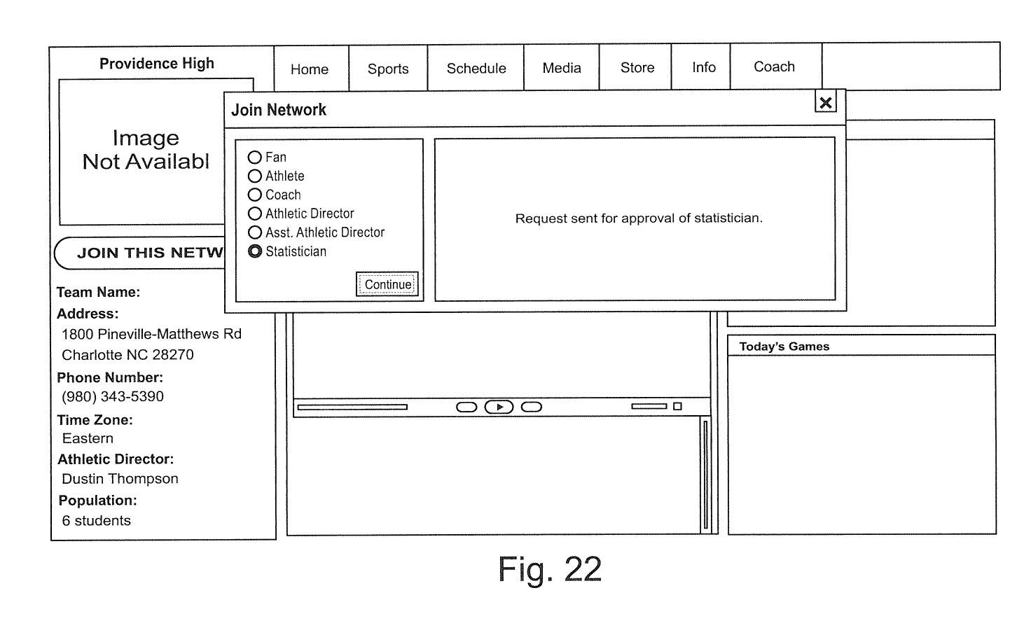

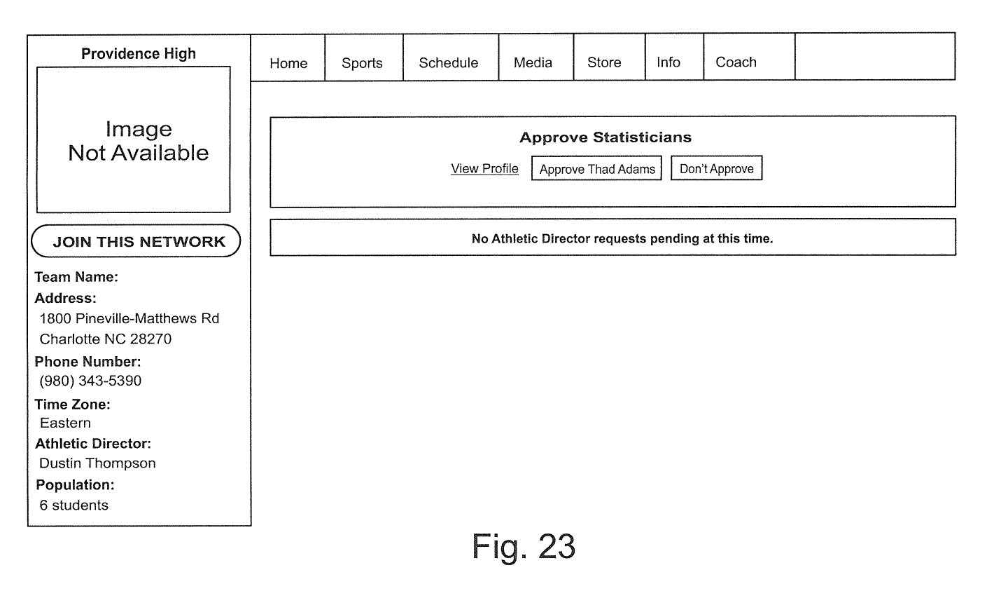

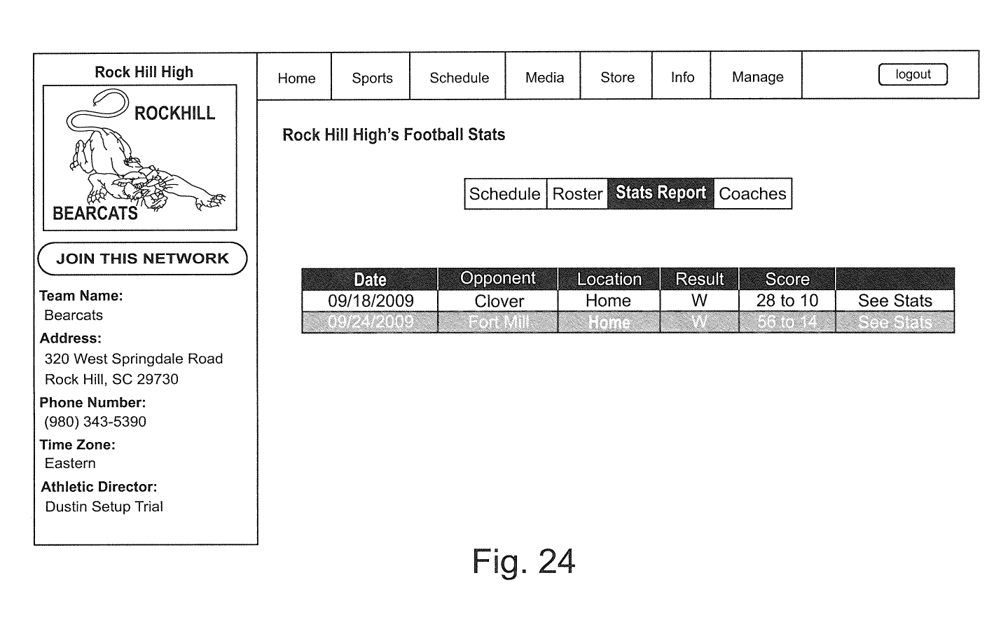

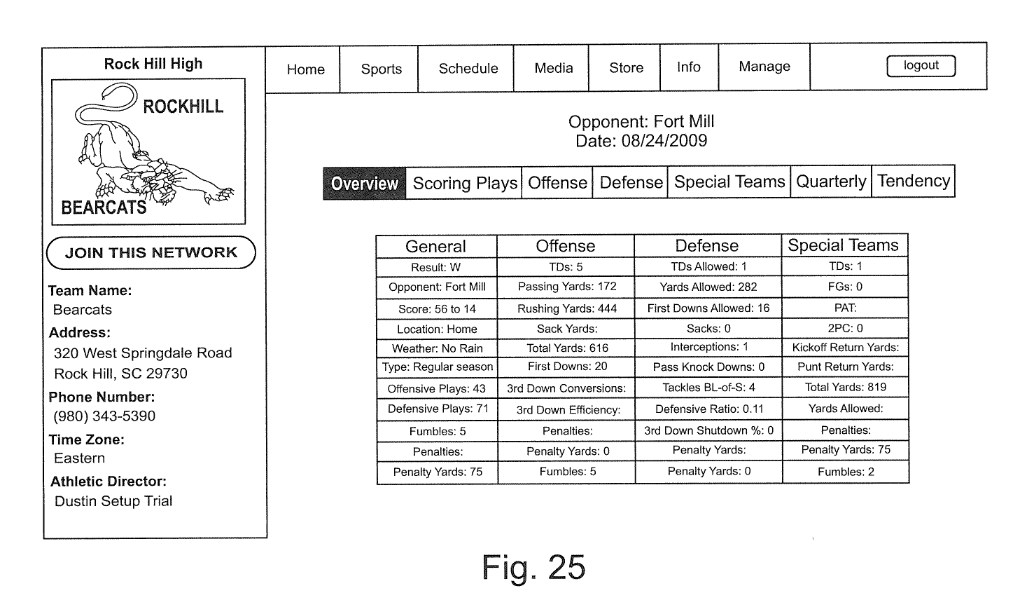

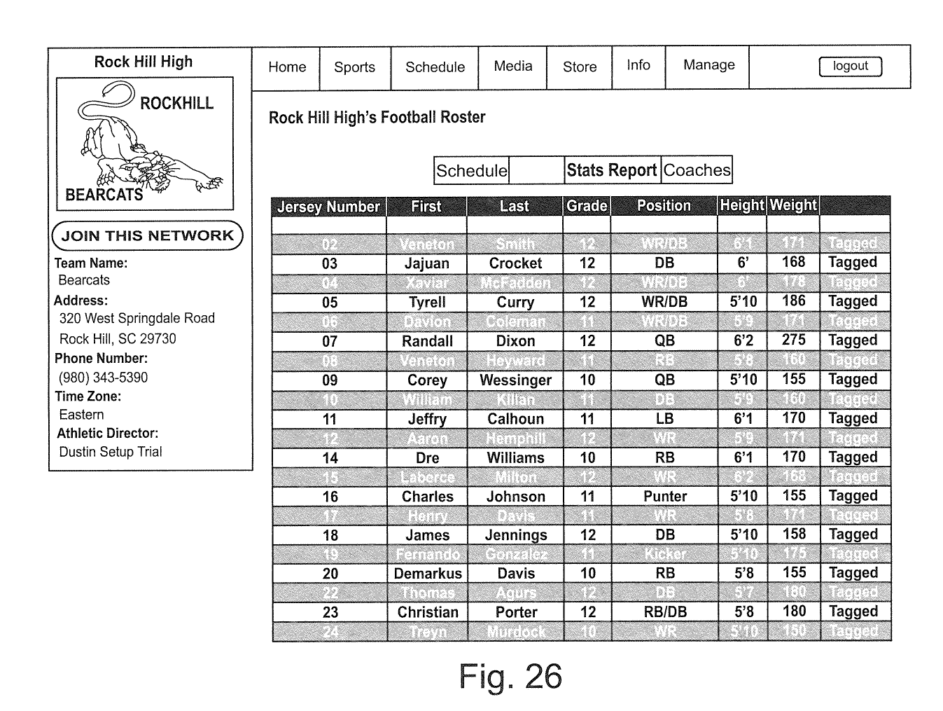

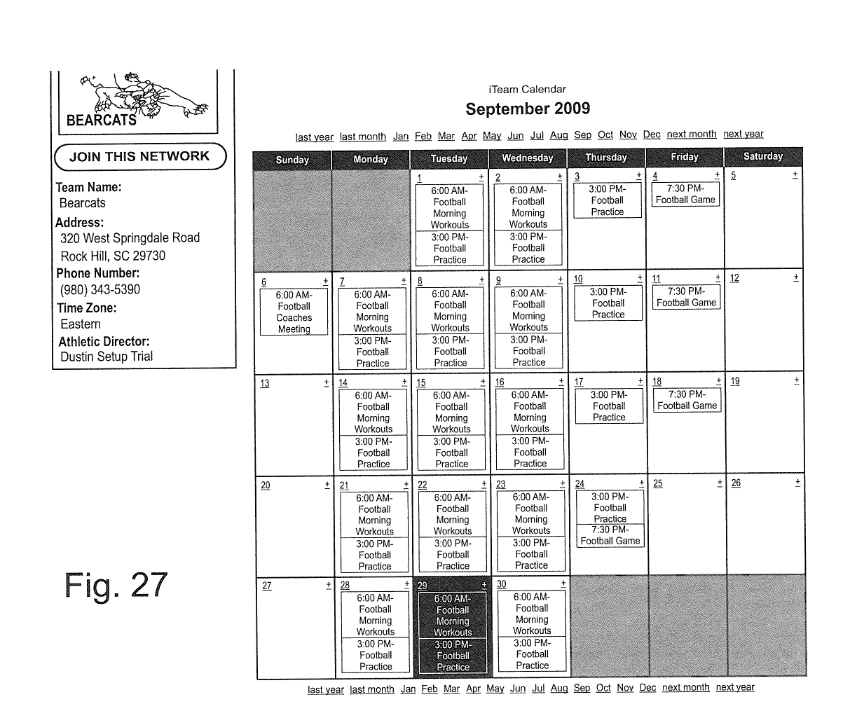

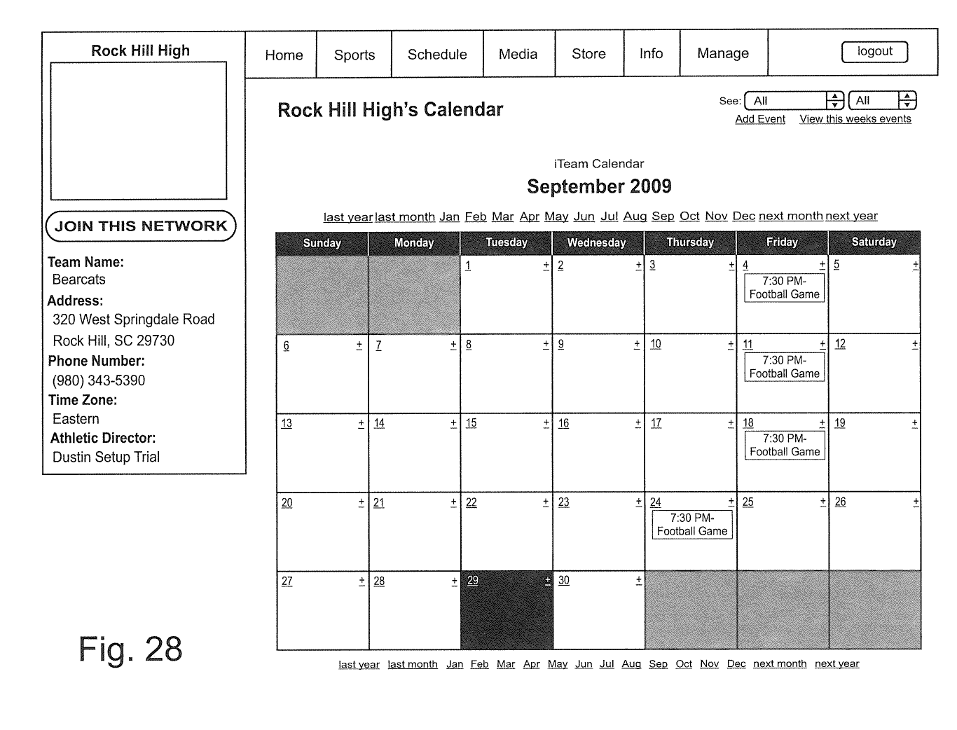

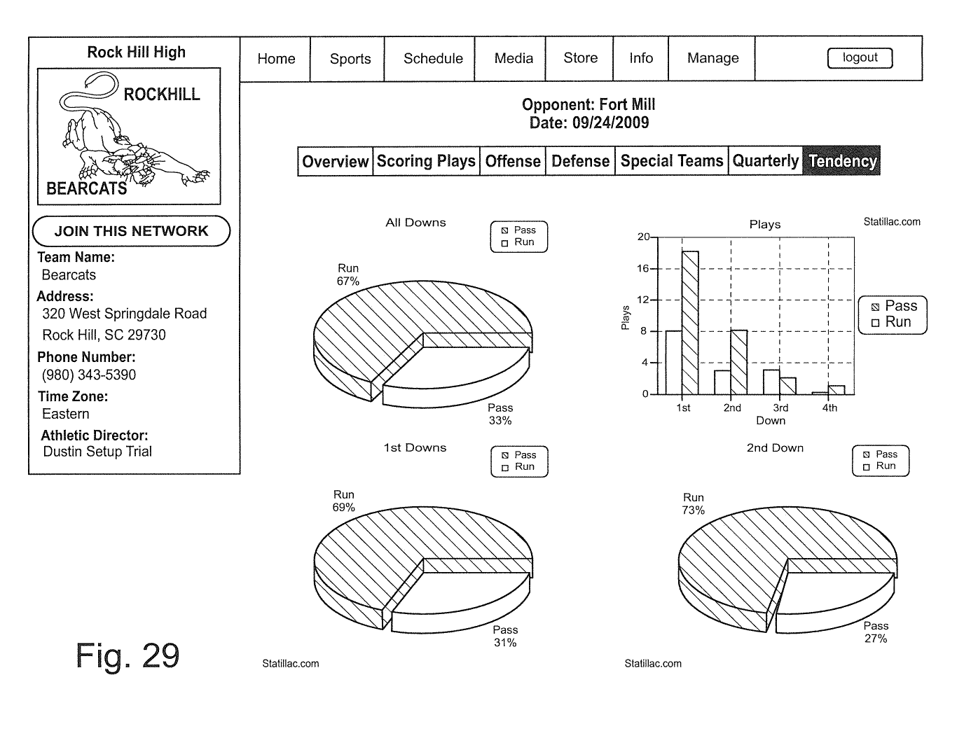

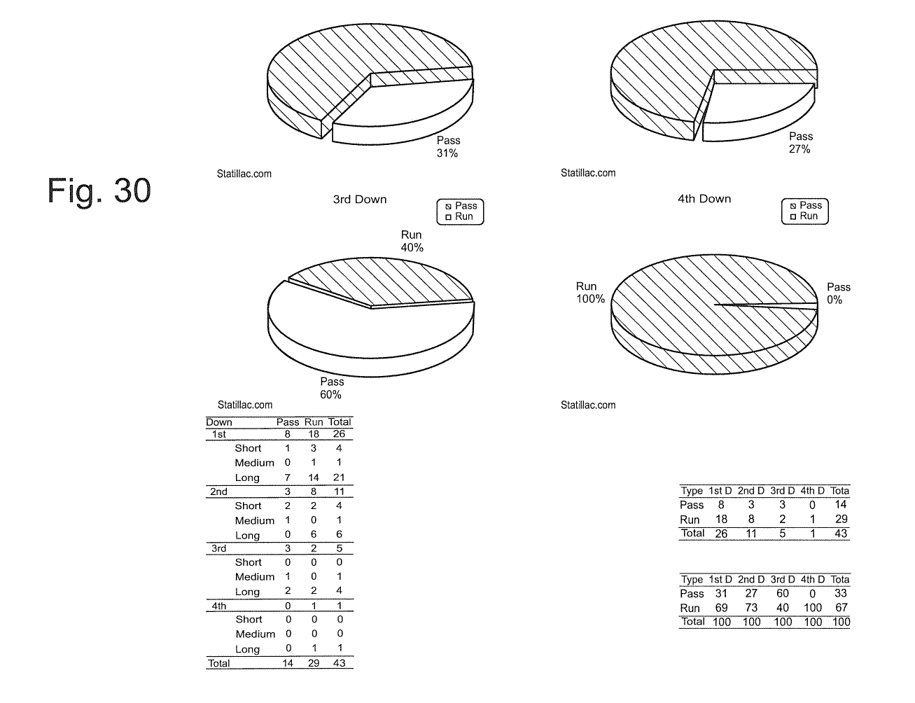

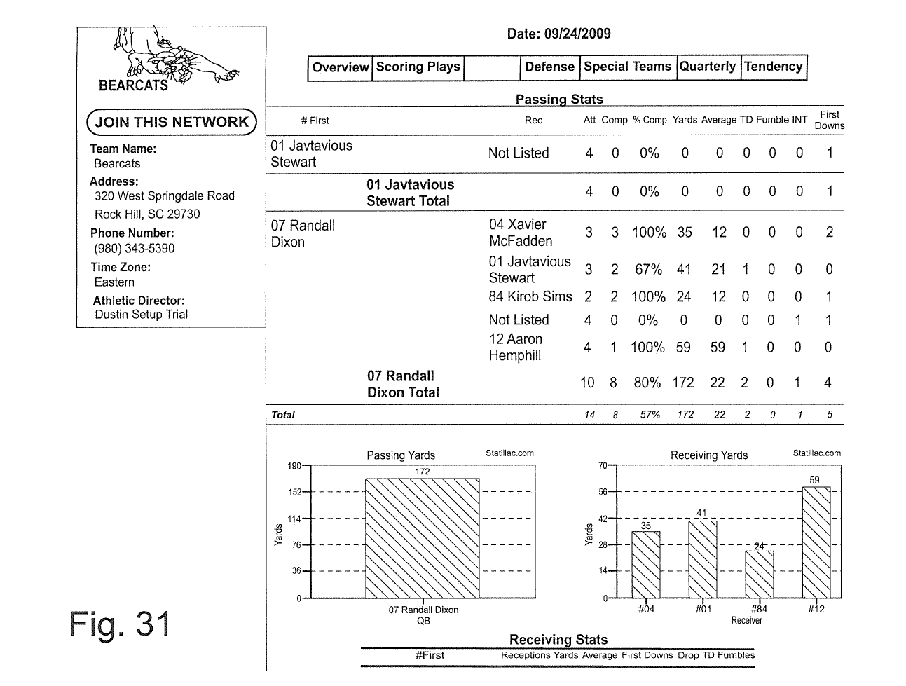

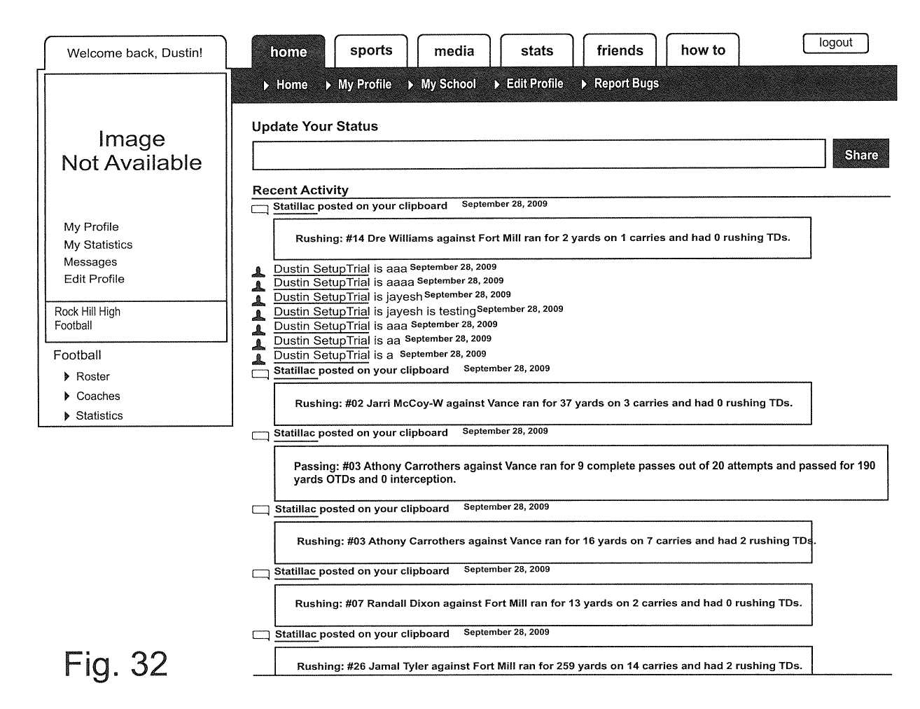

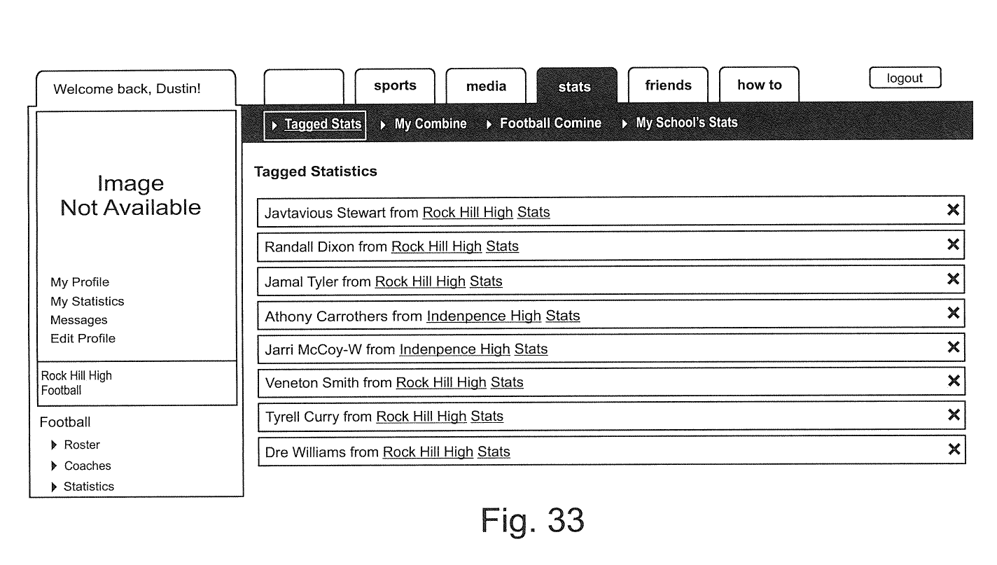

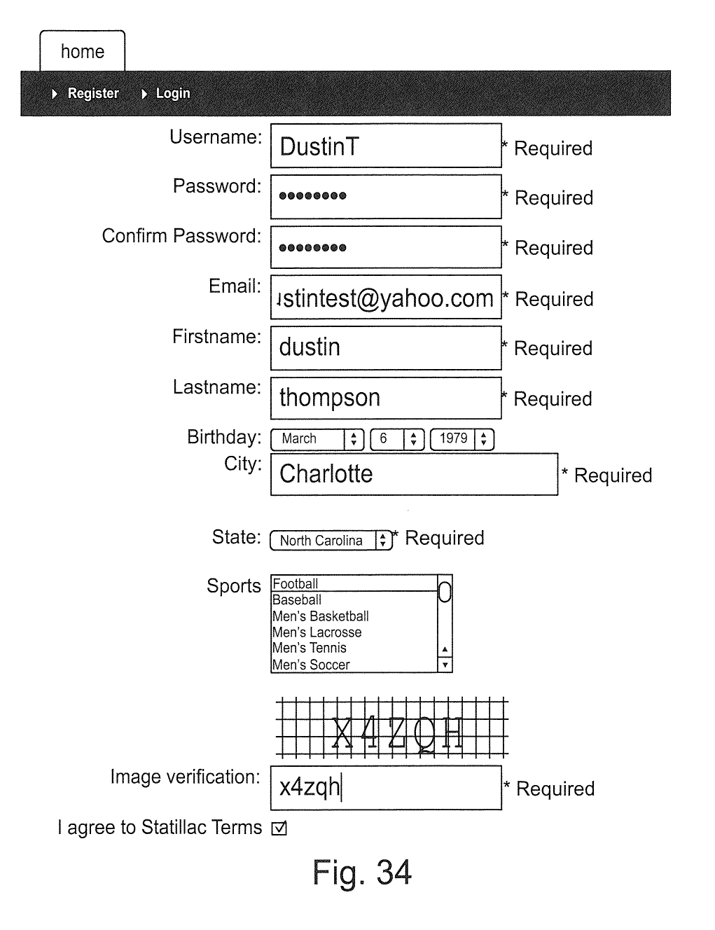

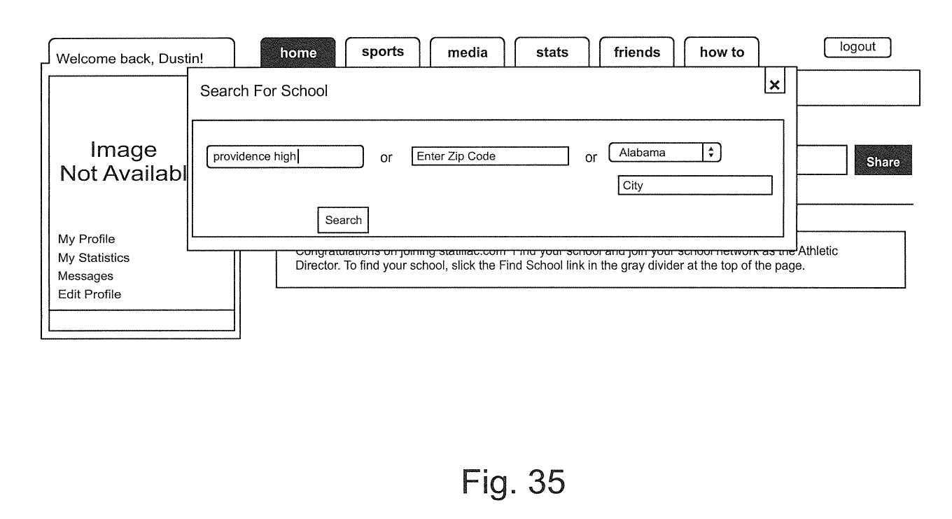

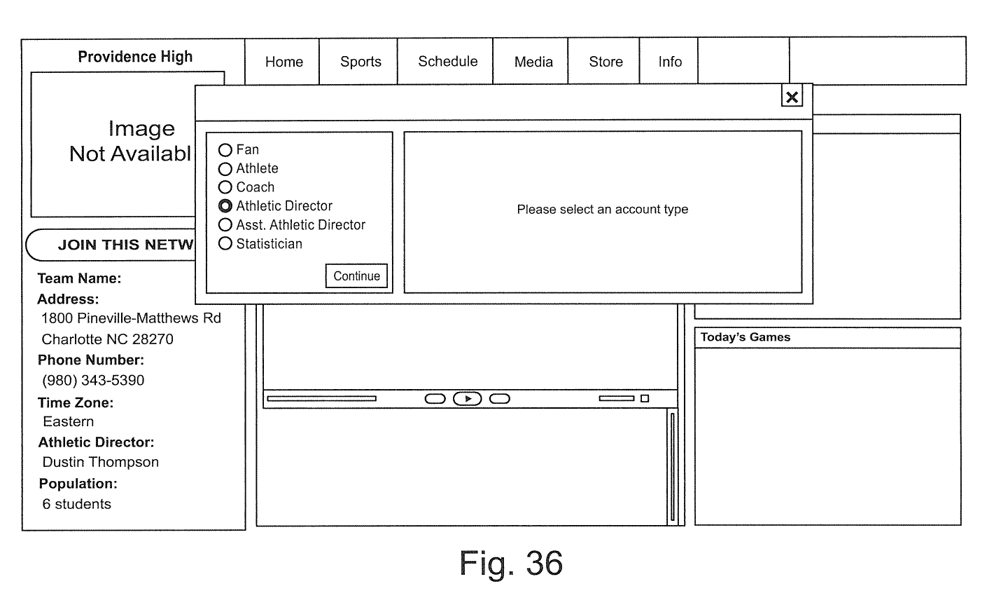

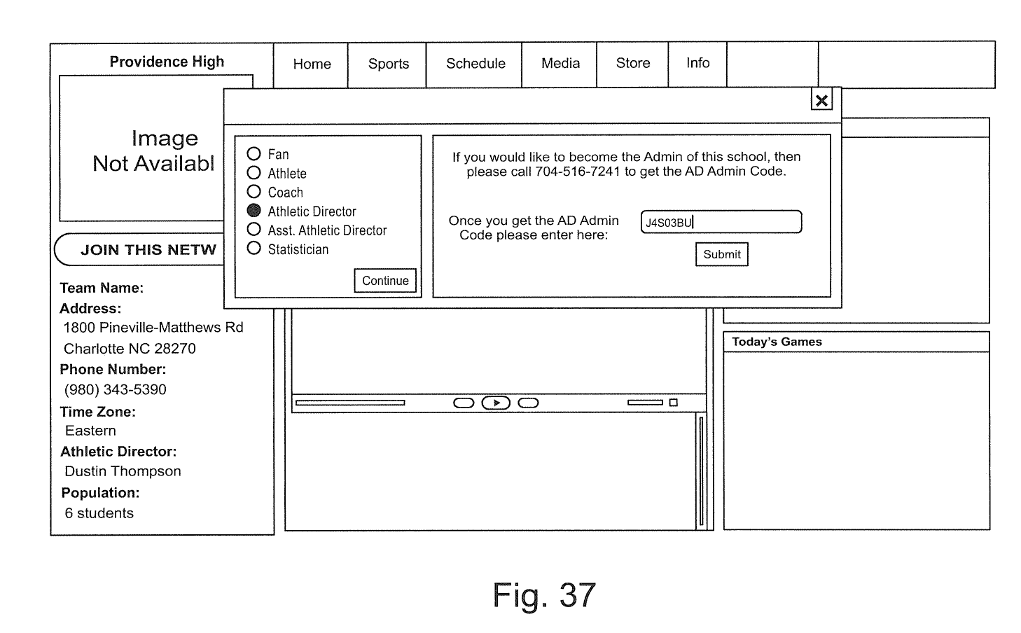

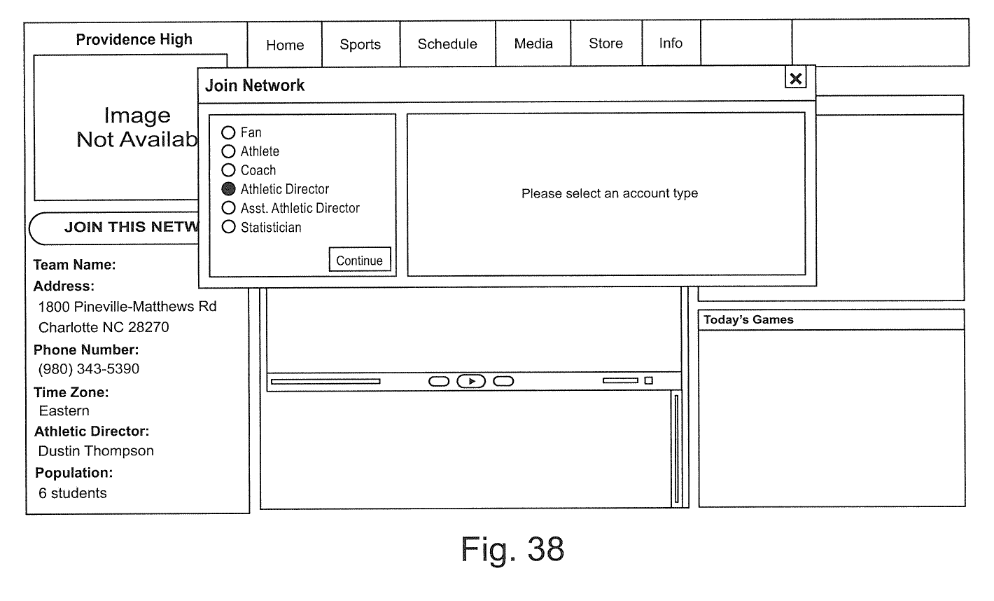

The system and it mode of operation is further illustrated in the screen shots, FIGS. 12-38, inclusive.

In the above description, certain terms have been used, such as Athletic Director, Coach, etc. to indicate status within the system. However, these terms are used by way of example only, and it is within the scope of the invention to, for example, include Athletic Directors in the player approval process or have an assistant or staff person approve players for Coaches instead of the Coach him or herself. The important principle is the organization with the hierarchy of rights and permissions, not a particular term applied to the users, or which users or groups of users have which rights.

A system and method for collecting and organizing game statistics for distribution, analysis and entertainment is described above. Various details of the invention may be changed without departing from the scope of the invention. Furthermore, the foregoing description of the preferred embodiment of the invention and best mode for practicing the invention are provided for the purpose of illustration only and not for the purpose of limitation, the invention being defined by the claims.

I claim:

1. A web-based and accessible sports statistics, information and application system configured to:
(a) establish a hierarchy of rights controlling access by users to sports statistics, information and applications stored in the system;
(b) establish a hierarchy of permissions to be granted to users based on the hierarchy of rights;
(c) establish a hierarchy of reports that can be downloaded by users based on their rights and permissions; and
(d) permit synchronization of team statistics, information and applications between the user's database information on a personal computer with database information on the website database.

2. A web-based and accessible sports statistics, information and application system according to claim 1, wherein the users comprise fans, athletic directors, coaches, players, scouts and statisticians.

3. A web-based and accessible sports statistics, information and application system according to claim 1, wherein the system is configured to allow the users to view and download reports of sports statistics based on the hierarchy of permissions to be granted to the users.

4. A web-based and accessible sports statistics, information and application system according to claim 1, wherein the system is configured to allow a school having one or more sports teams to subscribe to the web-based and accessible sports statistics, information and application system, and further wherein the system is configured to allow the school to designate an athletic director who may approve one or more coaches, and the system is configured to allow the one or more athletic directors and one or more coaches to approve one or more statisticians.

5. A web-based and accessible sports statistics, information and application system according to claim 4, wherein the system is configured to allow the athletic director and/or coach to create and upload player rosters for a sport and for a series of sports.

6. A web-based and accessible sports statistics, information and application system according to claim 5, wherein the system is configured to permit a player on a roster to access the system to view event schedules contained in the system.

7. A web-based and accessible sports statistics, information and application system according to claim 5, wherein the system is configured to permit the athletic director and/or coach to enter event schedules in the system, comprising practice sessions, workout sessions, team meetings, player meetings, and scheduled games.

8. A web-based and accessible sports statistics, information and application system according to claim 6, wherein the system is configured to allow only the athletic director and/or coach to view and schedule the events.

9. A web-based and accessible sports statistics, information and application system according to claim 6, wherein users other than athletic directors and coaches may only view scheduled games of the events schedule on the system.

10. A web-based and accessible sports statistics, information and application system according to claim 9, wherein the systems is configured to allow users to establish a user-created profile and synchronize the user-created profile with specific team and/or player specific data downloaded from the system.

11. A web-based and accessible sports statistics, information and application system according to claim 4, wherein the system is configured to allow only a user having rights and permissions of a statistician to download from the system software for creating team and player statistics by entering data into the system and synchronize player roster data with the player roster created by an athletic director or coach.

12. A web-based and accessible sports statistics, information and application system according to claim 4, wherein the system is configured to permit an athletic director, coach and statistician to upload statistics to the system.

13. A method of operating a web-based and accessible sports statistics, information and application system, comprising the steps of:
(a) establishing a hierarchy of rights controlling access by users to sports statistics stored in the system;
(b) establishing a hierarchy of permissions to be granted to users based on the hierarchy of rights;
(c) establishing a hierarchy of reports that can be downloaded by users based on their rights and permissions; and
(d) permitting synchronization of a team roster and team statistics between the user's database information on a personal computer with database information on the website database.

14. A method of operating a sports statistics, information and application system according to claim 13, wherein the users comprise fans, athletic directors, coaches, players, scouts and statisticians.

15. A method of operating a sports statistics, information and application system according to claim 13, and including the step of allowing the users to view and download reports of sports statistics based on the hierarchy of permissions to be granted to the users.

16. A method of operating a sports statistics, information and application system according to claim 13, and including the steps of configuring the system to allow a school having one or more sports teams to subscribe to the web-based and accessible sports statistics, information and application system, and allowing the school to designate an athletic director who may approve one or more coaches, and the system is configured to allow the one or more athletic directors and one or more coaches to approve one or more statisticians.

17. A method of operating a sports statistics, information and application system according to claim 16, and including the step of allowing the athletic director and/or coach to create and upload player rosters for a sport and for a series of sports.

18. A method of operating a sports statistics, information and application system according to claim 16, and including the step of permitting a player on a roster to access the system to view event schedules contained in the system.

19. A method of operating a sports statistics, information and application system according to claim 5, and including the step of permitting the athletic director and/or coach to enter event schedules in the system, comprising practice sessions, workout sessions, team meetings, player meetings, and scheduled games.

20. A method of operating a sports statistics, information and application system according to claim 6, and including the step of allowing only the athletic director and/or coach to view and schedule the events.

21. A method of operating a sports statistics, information and application system according to claim 6, wherein users other than athletic directors and coaches may only view scheduled games of the events schedule on the system.

22. A method of operating a sports statistics, information and application system according to claim 9, wherein the systems is configured to allow users to establish a user-created profile and synchronize the user-created profile with specific team and/or player specific data downloaded from the system.

23. A method of operating a sports statistics, information and application system according to claim 4, wherein the system is configured to allow only a user having rights and permissions of a statistician to download from the system software for creating team and player statistics by entering data into the system and synchronize player roster data with the player roster created by an athletic director or coach.

24. A method of operating a sports statistics, information and application system according to claim 4, wherein the system is configured to permit an athletic director, coach and statistician to upload statistics to the system.
